(19) United States
(12) Patent Application Publication
(10) Pub. No.: US 2011/0105004 A1
(43) Pub. Date: May 5, 2011

(54) FAN SYSTEM FOR VENTING A VEHICLE

(75) Inventors: Alan L. Browne, Grosse Pointe, MI (US); Jan H. Aase, Oakland Township, MI (US); Nancy L. Johnson, Northville, MI (US); James Holbrook Brown, Costa Mesa, CA (US)

(73) Assignee: GM GLOBAL TECHNOLOGY OPERATIONS, INC., Detroit, MI (US)

(21) Appl. No.: 12/753,275

(22) Filed: Apr. 2, 2010

Related U.S. Application Data
(60) Provisional application No. 61/256,408, filed on Oct. 30, 2009.

(51) Int. Cl. B60H 1/24; F04D 25/02; B60H 1/00

(52) U.S. Cl. 454/75; 417/321; 454/140

(57) ABSTRACT

A fan system includes a first fluid region having a first temperature and a second fluid region having a second temperature that is different from the first temperature. An energy harvesting system is disposed in contact with each of the first fluid region and the second fluid region. A fan is driven by an energy harvesting system in response to the temperature difference between the first fluid region and the second fluid region.

### CROSS-REFERENCE TO RELATED APPLICATIONS

This application claims the benefit of U.S. Provisional Patent Application Ser. No. 61/256,408, filed on Oct. 30, 2009, the disclosure of which is hereby incorporated by reference.

### TECHNICAL FIELD

The present invention generally relates to a vehicle, and more specifically, to driving a fan to cool the vehicle.

### BACKGROUND OF THE INVENTION

Vehicles are traditionally powered by an engine, which drives the vehicle and provides power to charge a battery of the vehicle. The battery provides power for starting the engine and for operating various vehicle accessories. Advancements in technology and desire for driver conveniences have increased the number of vehicle accessories, as well as increased the load, i.e., power demand, on the engine and/or the battery required to power the vehicle accessories. Accordingly, arrangements for extending driving range and increasing the fuel efficiency of the vehicle are desirable. Therefore, systems that reduce the power load on the vehicle's traditional power sources, i.e., the engine and/or the battery, are desirable.

### SUMMARY OF THE INVENTION

A fan system includes a first fluid region having a first temperature and a second fluid region having a second temperature that is different from the first temperature. An energy harvesting system is disposed in contact with the first fluid region and the second fluid region. A fan is driven by the energy harvesting system in response to the temperature difference between the first fluid region and the second fluid region. At least one vent is located between the first fluid region and the second fluid region. A vent actuator is connected to the vent to actuate movement of the vent between an open position and a closed position. The fan system may be used in a vehicle where the first fluid region is located within the vehicle and the second fluid region is located outside the vehicle. The energy harvesting system may be a heat engine configured for converting thermal energy to mechanical energy and including a shape-memory alloy.

A method for changing a fluid temperature for the vehicle includes driving the heat engine by converting thermal energy to mechanical energy with a shape-memory alloy disposed in contact with the first fluid region located within the vehicle and the second fluid region located outside the vehicle. Additionally, the method includes driving a fan supported by the vehicle with the heat engine in response to the temperature difference between the first fluid region and the second fluid region.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a partial schematic illustration of a vehicle having a fan system;

FIG. 2 is a schematic perspective view of a first embodiment of a heat engine for the fan system of FIG. 1; and

FIG. 3 is a schematic illustration view of the fan system of FIG. 1.

### DESCRIPTION OF THE PREFERRED EMBODIMENTS

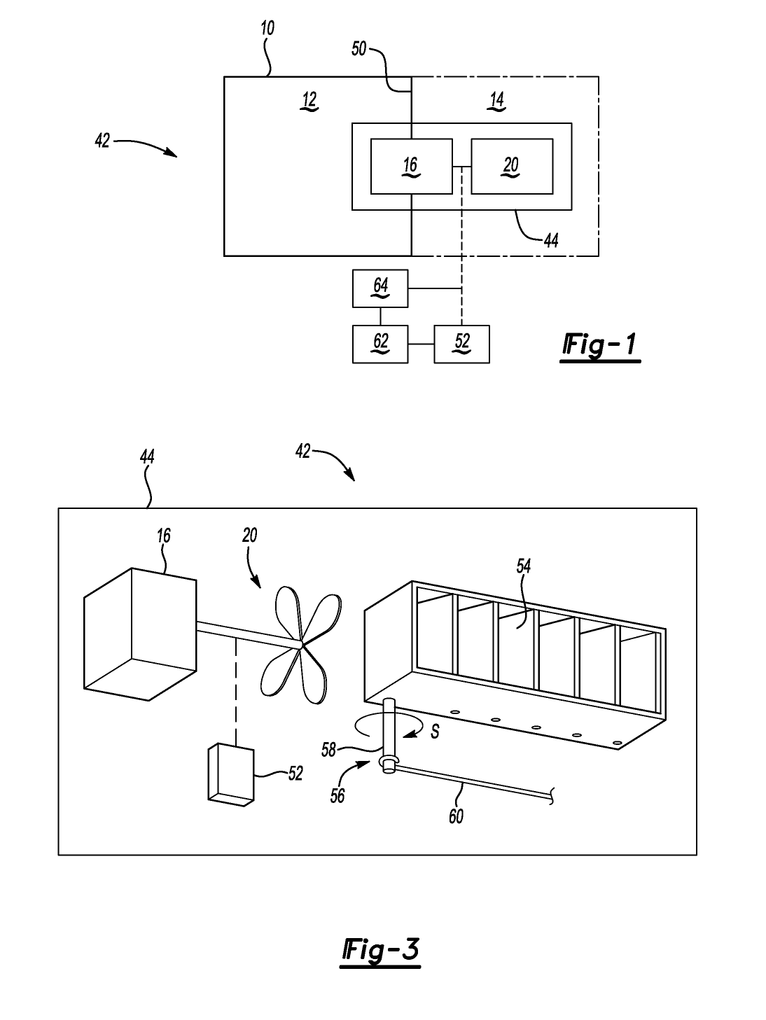

Referring to the Figures, wherein like reference numerals refer to like elements, a vehicle is shown generally at 10 in FIG. 1. The vehicle 10 includes a fan system 42. The fan system 42 utilizes the temperature difference between a first fluid region 12 and a second fluid region 14 to generate mechanical energy to drive a fan 20. The fan system 42 is illustrated in a vehicle 10. However, it is to be appreciated that the fan system 42 may also be useful for non-automotive applications such as, but not limited to, household and industrial cooling applications.

The fan system 42 is mounted to the vehicle 10, such as mounted to or incorporated in a roof 50 of the vehicle 10. Alternatively, the fan system 42 may be mounted to an exterior of the vehicle 10, the interior of the vehicle 10, underneath the vehicle 10, or in a window of the vehicle 10. The fan system 42 is mounted in a location that exposes the fan system 42 to a first fluid region 12 in the passenger compartment of the vehicle 10 and a second fluid region 14 outside of the passenger compartment. The first fluid region 12 and the second fluid region 14 have a temperature difference therebetween. For example, the temperature difference may be generated by a sun load on the vehicle 10 warming the passenger compartment.

As described below, the temperature difference actuates the fan system 42 to drive the fan 20 and cool the passenger compartment of the vehicle 10. As a result, the cooling demand on the vehicle 10 cooling system may be reduced, thus reducing the power demand on the power source of the vehicle 10. Additionally, the reduced demand on the cooling system may allow for the cooling system to be decreased in size and capacity, thus providing the vehicle 10 with more energy and weight savings for the vehicle 10. The reduced demand on the power sources for the vehicle 10 corresponds to increased fuel economy for the vehicle 10, or increased vehicle range in the case of an electric vehicle. Additionally, the fan system 42 preferably operates when the vehicle 10 is not running, therefore the passenger compartment may be cooled when the vehicle 10 is parked.

The fan system 42 may operate autonomously from the vehicle 10, such that, the power to operate the fan system 42 is entirely independent or substantially independent of the main power sources for the vehicle 10, as explained in further detail below.

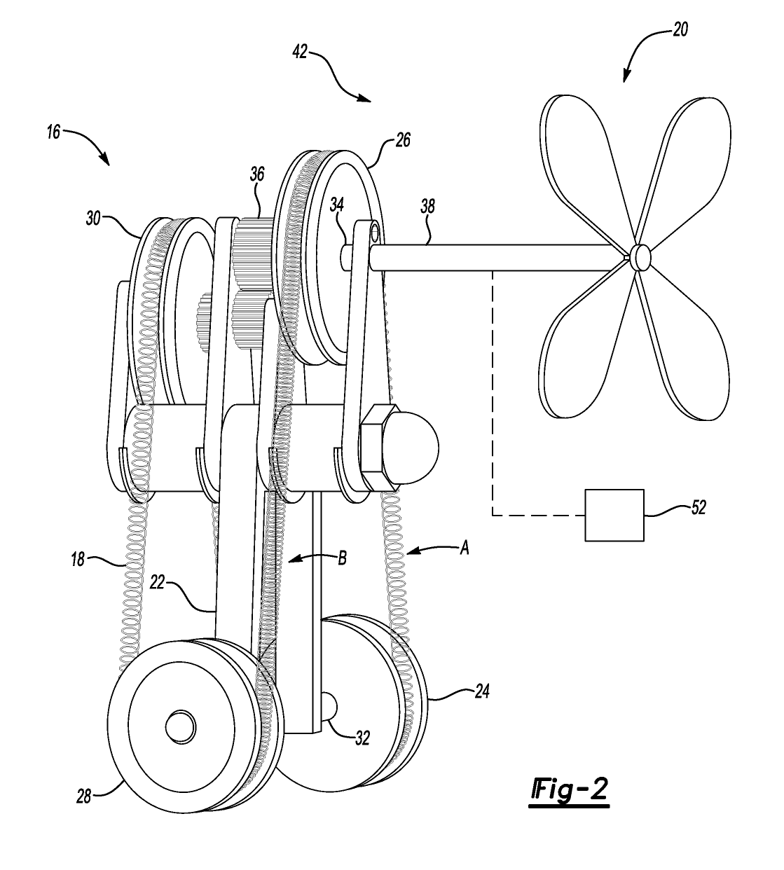

The fan system 42 includes an energy source such as an energy harvesting system 16. The energy harvesting system 16 may be a heat engine or a piezo-based vibrational energy harvesting system. The energy harvesting system 16 is configured for converting vibrational or thermal energy, e.g., heat, to mechanical energy to drive a fan 20. The fan 20 is directly driven by the energy harvesting system 16. For example, when the energy harvesting system 16 is a heat engine the temperature difference between the first fluid region 12 and the second fluid region 14 will activate a shape-memory alloy (SMA) 18 (shown in FIG. 2), as explained in detail below, to convert the thermal energy to mechanical energy and drive the fan 20.

Additionally, a battery 52 may be attached to the energy harvesting system 16. The battery 52 may store energy from the output of the energy harvesting system 16 and drive the fan 20. Alternatively, or in addition to the battery 52, a flywheel 64 may be used to drive the fan 20. The flywheel 64 may be spun with mechanical energy from the energy harvesting system 16. The flywheel 64 may store energy from the energy harvesting system 16 and drive the fan 20 independently. Therefore, operation of the fan 20 may be independent of operation of the energy harvesting system 16.

Additionally, the battery 52 may drive the fan 20 independent from the operation of the energy harvesting system 16. For example, the battery 52 may operate the fan using energy that was generated by a piezo-based vibrational energy harvesting system that harvested energy when the vehicle 10 was operating to operate the fan system 42 when the vehicle is parked. The battery 52 may also operate the fan system 42 independently when the energy harvesting system 16 is a heat engine. The battery 52 may store the energy when the temperature differential between the first fluid region 12 and the second fluid region 14 is sufficient to operate the heat engine and drive the fan 20 later even if the temperature differential between is insufficient to generate a phase change for the SMA 18.

A controller 62 may be included to activate the battery 52 to drive the fan 20 when desired. The controller 62 may include switches to disconnect the battery 52 from the fan 20 for charging the battery 52 by the energy harvesting system 16, and to connect the battery 52 to then drive the fan 20. A generator (not shown) may be utilized to convert the mechanical energy from the energy harvesting system 16 to electrical energy for charging the battery 52. The controller 62 may also include a temperature sensor to measure the temperature of the first fluid region 12, i.e. the passenger compartment of the vehicle 10, and when the first fluid region 12 is above a predetermined temperature the controller 62 activates the battery 52 to drive the fan 20. Alternatively, the controller 62 may utilize an active material element, such as a thermally activated SMA, or a paraffin wax actuator to activate operation of the fan system 42. A paraffin wax actuator expands significantly when heated above its solid to liquid phase transformation temperature and reversibly contracts when cooled and may be utilized if autonomous temperature activation is desired. The controller 62 may additionally include a sensor to determine when the vehicle 10 is parked or in motion to operate the fan system 42 only when the vehicle 10 is parked. The controller 62 may further provide the option of a switch to manually turn the fan system 42 on or off.

Referring to FIG. 2, this illustrates an embodiment where the energy harvesting system 16 is a heat engine which includes a shape-memory alloy 18 having a crystallographic phase changeable between austenite and martensite in response to the temperature difference of the first fluid region 12 and the second fluid region 14 (FIG. 1).

As used herein, the terminology “shape-memory alloy” refers to alloys which exhibit a shape-memory effect. That is, the shape-memory alloy 18 may undergo a solid state phase change via molecular or crystalline rearrangement to shift between a martensite phase, i.e., “martensite”, and an austenite phase, i.e., “austenite”. Stated differently, the shape-memory alloy 18 may undergo a displacive transformation rather than a diffusional transformation to shift between martensite and austenite. In general, the martensite phase refers to the comparatively lower-temperature phase and is often more deformable than the comparatively higher-temperature austenite phase. The temperature at which the shape-memory alloy 18 begins to change from the austenite phase to the martensite phase is known as the martensite start temperature, Mₛ. The temperature at which the shape-memory alloy 18 completes the change from the austenite phase to the martensite phase is known as the martensite finish temperature, M_{f}. Similarly, as the shape-memory alloy 18 is heated, the temperature at which the shape-memory alloy 18 begins to change from the martensite phase to the austenite phase is known as the austenite start temperature, Aₛ. And, the temperature at which the shape-memory alloy 18 completes the change from the martensite phase to the austenite phase is known as the austenite finish temperature, A_{f}.

Therefore, the shape-memory alloy 18 may be characterized by a cold state, i.e., when a temperature of the shape-memory alloy 18 is below the martensite finish temperature M_{f} of the shape-memory alloy 18. Likewise, the shape-memory alloy 18 may also be characterized by a hot state, i.e., when the temperature of the shape-memory alloy 18 is above the austenite finish temperature A_{f} of the shape-memory alloy 18.

In operation, i.e., when exposed to the temperature difference of first fluid region 12 and the second fluid region 14, the shape-memory alloy 18, if pre-strained or subjected to tensile stress, can change dimension upon changing crystallographic phase to thereby convert thermal energy to mechanical energy. That is, the shape-memory alloy 18 may change crystallographic phase from martensite to austenite and thereby dimensionally contract if pre-strained pseudoplastically so as to convert thermal energy to mechanical energy. More specifically, the shape memory alloy 18 may dimensionally contract if the shape memory alloy 18 has been previously pre-strained pseudoplastically by the application of the strain. Conversely, the shape-memory alloy 18 may change crystallographic phase from austenite to martensite and if under stress thereby dimensionally expand. That is, the shape memory alloy 18 may dimensionally contract under stress to convert thermal energy to mechanical energy, and then stretch back during the martensite phase to repeat the cycle.

The term “pre-strained pseudoplastically” refers to stretching the shape memory alloy 18 while in the martensite phase so that the strain exhibited by the shape memory alloy 18 under that loading condition is not fully recovered when unloaded, where purely elastic strain would be fully recovered. For a non-shape memory material, the non-recovered portion of that strain would be due to plastic deformation, which would be permanent for that material. In the case of the shape memory alloy 18, it is possible to load the material such that the elastic strain limit is surpassed and deformation takes place in the martensitic crystal structure of the material prior to exceeding the true plastic strain limit of the material. Strain of this type, between those two limits, is pseudoplastic strain, called such because upon unloading it appears to have plastically deformed, but when heated to the point that the shape memory alloy 18 transforms to its austenite phase, that strain can be recovered, returning the shape memory alloy 18 to the original length observed prior to any load being applied.

The shape-memory alloy 18 may have any suitable composition. In particular, the shape-memory alloy 18 may include an element selected from the group of cobalt, nickel, titanium, indium, manganese, iron, palladium, zinc, copper, silver, gold, cadmium, tin, silicon, platinum, gallium, and combinations thereof. For example, suitable shape-memory alloys 18 may include nickel-titanium based alloys, nickel-aluminum based alloys, nickel-gallium based alloys, indium-titanium based alloys, indium-cadmium based alloys, nickel-cobalt-aluminum based alloys, nickel-manganese-gallium based alloys, copper based alloys (e.g., copper-zinc alloys, copper-aluminum alloys, copper-gold alloys, and copper-tin alloys), gold-cadmium based alloys, silver-cadmium based alloys, manganese-copper based alloys, iron-platinum based alloys, iron-palladium based alloys, and combinations thereof The shape-memory alloy 18 can be binary, ternary, or any higher order so long as the shape-memory alloy 18 exhibits a shape memory effect, e.g., a change in shape orientation, damping capacity, and the like. A skilled artisan may select the shape-memory alloy 18 according to desired operating temperatures within the compartment 40 (FIG. 1), as set forth in more detail below. In one specific example, the shape-memory alloy 18 may include nickel and titanium.

Further, the shape-memory alloy 18 may have any suitable form, i.e., shape. For example, the shape-memory alloy 18 may have a form selected from the group of bias members, tapes, wires, bands, continuous loops, and combinations thereof. The embodiment shown in FIG. 2 illustrates one variation; the shape-memory alloy 18 may be formed as a continuous loop spring.

The shape-memory alloy 18 may convert thermal energy to mechanical energy via any suitable manner. For example, the shape-memory alloy 18 may activate a pulley system (shown generally in FIG. 2), engage a lever (not shown), rotate a flywheel (not shown), engage a screw (not shown), and the like.

The fan 20 is driven by the energy harvesting system 16. That is, when the energy harvesting system 16 is a heat engine the mechanical energy resulting from the conversion of thermal energy by the shape-memory alloy 18 may drive the fan 20. In particular, the aforementioned dimensional contraction and the dimensional expansion of the shape-memory alloy 18 may drive the fan 20.

More specifically, in one variation shown in FIG. 2, the energy harvesting system 16 may include a frame 22 configured for supporting one or more wheels 24, 26, 28, 30 disposed on a plurality of axles 32, 34. The wheels 24, 26, 28, 30 may rotate with respect to the frame 22, and the shape-memory alloy 18 may be supported by, and travel along, the wheels 24, 26, 28, 30. Speed of rotation of the wheels 24, 26, 28, 30 may optionally be modified by one or more gear sets 36. Moreover, the generator 20 may include a drive shaft 38 attached to the wheel 26. As the wheels 24, 26, 28, 30 turn about the axles 32, 34 of the energy harvesting system 16 in response to the dimensionally expanding and contracting shape-memory alloy 18, the drive shaft 38 rotates and drives the fan 20.

Referring again to FIG. 1, the fan system is shown generally at 42. The fan system 42 is likewise configured for generating mechanical energy to drive the fan 20 without requiring power from an outside source. More specifically, as shown in FIG. 1, the fan system 42 includes the first fluid region 12 having a first temperature and the second fluid region 14 having a second temperature that is different from the first temperature. For example, the first temperature may be higher than the second temperature. The temperature difference between the first temperature and the second temperature may be greater than or equal to about 5° C., e.g., greater than or equal to about 10° C.

As shown generally in FIG. 1, the energy harvesting system 16, and more specifically, the shape-memory alloy 18 (FIG. 2) of the energy harvesting system 16 as a heat engine, is disposed in contact with each of the first fluid region 12 and the second fluid region 14. The energy harvesting system 16 and the fan 20 may be mounted to the vehicle 10 in any location of the vehicle 10 as long as the shape-memory alloy 18 is disposed in contact with each of the first fluid region 12 and the second fluid region 14. Therefore, the shape-memory alloy 18 may change crystallographic phase between austenite and martensite upon contact with one of the first fluid region 12 and the second fluid region 14. For example, upon contact with the first fluid region 12, the shape-memory alloy 18 may change from martensite to austenite. Likewise, upon contact with the second fluid region 14, the shape-memory alloy 18 may change from austenite to martensite.

Further, the shape-memory alloy 18 may change dimension upon changing crystallographic phase to thereby convert thermal energy to mechanical energy. More specifically, the shape-memory alloy 18 may dimensionally contract upon changing crystallographic phase from martensite to austenite and may dimensionally expand if under stress when changing crystallographic phase from austenite to martensite to thereby convert thermal energy to mechanical energy. Therefore, for any condition wherein the temperature difference exists between the first temperature of the first fluid region 12 and the second temperature of the second fluid region 14, i.e., wherein the first fluid region 12 and the second fluid region 14 are not in thermal equilibrium, the shape-memory alloy 18 may dimensionally expand and contract upon changing crystallographic phase between martensite and austenite. And, the change in crystallographic phase of the shape-memory alloy 18 may cause the shape-memory alloy to rotate the pulleys 24, 26, 28, 30 and, thus, drive the fan 20.

In operation, with reference to the fan system 42 of FIG. 1 and described with respect to the example configuration of the shape-memory alloy 18 shown in FIG. 2, one wheel 28 may be immersed in the first fluid region 12 while another wheel 24 may be immersed in the second fluid region 14. As one area (generally indicated by arrow A) of the shape-memory alloy 18 dimensionally expands when in contact with the second fluid region 14, another area (generally indicated by arrow B) of the shape-memory alloy 18 in contact with the first fluid region 12 dimensionally contracts. Alternating dimensional contraction and expansion of the continuous spring loop form of the shape-memory alloy 18 upon exposure to the temperature difference between the first fluid region 12 and the second fluid region 14 may cause the shape memory alloy 18 to convert potential mechanical energy to kinetic mechanical energy, thereby driving the pulleys 24, 26, 28, 30 and converting thermal energy to mechanical energy.

Referring to FIG. 3, the energy harvesting system 16 and the fan 20 may be surrounded by a housing 44. The housing 44 preferably includes vents 54. Vents 54 may be arranged such that during operation of the energy harvesting system 16 the fan 20 circulates to move air from the first fluid region 12 to the second fluid region 14. That is, the vents 54 are located between the first fluid region 12 and the second fluid region 14 to move the heated air in the first fluid region 12 to the cooler second fluid region 14 to provide a cooling effect to the first fluid region 12. When the fan system 42 is mounted to a vehicle 10 this arrangement will vent hot air from within the passenger compartment to the cooler environment outside.

The vents 54 are preferably moveable between open and closed positions. An actuator 56 is connected to the vents 54 to actuate movement of the vents 54 in coordination with operation of the energy harvesting system 16. In the embodiment shown, the actuator 56 includes a vent shaft 58 which is spring biased in a closed position, as indicated by arrow S. A shape-memory alloy wire 60 is secured to the vent shaft 58 and to a ground, such as the housing 44. The wire 60 may be selected from the same materials and operates in a similar manner to the shape-memory alloy 18 as described above. However, the wire 60 may be a different material than the shape-memory alloy 18, but act in a similar manner. For example, the wire 60 may be an active material element such as another SMA alloy, or a paraffin wax actuator (as described above). For those embodiments in which an on-demand non-temperature based activation is desired then SMA, EAP, and piezo uni- or bi-morphs are comprehended active material based actuators 56.

The wire 60 may be activated at a pre-determined actuation temperature. When the temperature within the first fluid region 12 increases above the actuation temperature this causes the wire 60 to actuate. For example, if the wire 60 is an SMA alloy to change phase, thus shortening in length. The wire 60 will overcome the spring bias S and rotate the vent shaft 58 in an opposing direction from the spring bias S, to open the vents 54. The vents 54 will remain open while the wire 60 is above the activation temperature. When the wire 60 is exposed to a temperature below the pre-determined actuation temperature, i.e. the temperature within the first fluid region 12 decreases, the wire 60 will return to the inactive state, i.e. undergo a phase change and return to the original length when the wire 60 is an SMA alloy. The spring bias S will rotate the vent shaft 58 to move the vents 54 to a closed position.

The material selected to form the wire 60 may be selected based upon the pre-determined actuation temperature for opening the vents 54. That is, the material of the wire 60 may be selected to provide actuation at a desired temperature. For example, the material for the wire 60 may undergo a phase change at a temperature that corresponds to a temperature within the passenger compartment that is desirable to begin cooling. Although the shape-memory alloy 18 and the wire 60 do not require activation at the same moment the activation of the vents 54 and the fan 20 may be coordinated by the selection of the actuation temperature of the wire 60 and the actuation temperature differential of the shape-memory alloy 18.

The actuator 56 shown discloses one embodiment for activated movement of the vents 54. Other actuators and actuator arrangements may be utilized including movement of the vent shaft 58 with the energy harvesting system 16. Additionally, the fan system 42 may provide an override feature to prevent actuation of the vent 54 or vent 54 and fan 20. Sensors, batteries, controllers or other instruments (not shown) may be included with the fan system 42 to provide control of the override feature. In this manner the fan system 42 may be temporarily disabled as desired. For example, it may be desirable to override the fan system 42 when it is raining, or when the vehicle 10 (shown in FIG. 1) is in motion. Alternatively, the fan system 42 may be connected to the vehicle 10 sensors or instruments to provide the override feature in coordination with the vehicle 10. However, the power to drive the energy harvesting system 16 and the fan 20 preferably remains substantially autonomous from the vehicle 10.

It is to be appreciated that for any of the aforementioned examples, the vehicle 10 and/or the fan system 42 may include a plurality of energy harvesting systems 16 and/or a plurality of fans 20. That is, one vehicle 10 may include more than one energy harvesting system 16 and/or fan 20. For example, one energy harvesting system 16 may drive more than one fan 20. Likewise, vehicle 10 may include more than one fan system 42, each including at least one energy harvesting system 16 and fan 20.

While the best modes for carrying out the invention have been described in detail, those familiar with the art to which this invention relates will recognize various alternative designs and embodiments for practicing the invention within the scope of the appended claims.

1. A fan system comprising:
a first fluid region having a first temperature;
a second fluid region having a second temperature that is different from the first temperature;
a energy harvesting system configured for converting thermal energy to mechanical energy and including a shape-memory alloy disposed in contact with each of the first fluid region and the second fluid region;
a fan driven by the heat engine in response to the temperature difference between the first fluid region and the second fluid region; and
at least one vent located between the first fluid region and the second fluid region, a vent actuator to actuate movement of the at least one vent between an open position and a closed position.

2. The fan system of claim 1, wherein the shape-memory alloy changes crystallographic phase between austenite and martensite upon contact with one of the primary fluid and the secondary fluid.

3. The fan system of claim 2, wherein the change in crystallographic phase of the shape-memory alloy drives the component.

4. The fan system of claim 1, wherein the shape-memory alloy dimensionally contracts upon changing crystallographic phase from martensite to austenite and dimensionally expands upon changing crystallographic phase from austenite to martensite.

5. The fan system of claim 1, wherein a temperature difference between the first temperature and the second temperature is more than or equal to about 5° C.

6. The fan system of claim 1, wherein the vent actuator further includes one of a shape-memory alloy wire and a paraffin wax actuator to actuate movement of the at least one vent in response to a change in temperature within the first fluid region.

7. A fan system for a vehicle comprising:
a first fluid region located within a vehicle having a first temperature;
a second fluid region located outside a vehicle having a second temperature that is different from the first temperature;
an energy harvesting system disposed in contact with each of the first fluid region and the second fluid region; and
a fan supported by the vehicle, wherein the fan is driven by the energy harvesting system in response to the temperature difference between the first fluid region and the second fluid region.

8. The fan system of claim 7, further including at least one vent located between the first fluid region and the second fluid region, a vent actuator to actuate movement of the at least one vent between an open position and a closed position.

9. The fan system of claim 7, wherein the energy harvesting system is one of a heat engine including a shape-memory alloy disposed in contact with each of the first fluid region and the second fluid region, and a piezo-based vibrational energy harvesting system.

10. The fan system of claim 9, wherein the shape-memory alloy changes crystallographic phase between austenite and martensite upon contact with one of the primary fluid and the secondary fluid.

11. The fan system of claim 9, wherein the change in crystallographic phase of the shape-memory alloy drives the component.

12. The fan system of claim 7, wherein the vent actuator further includes at least one of a shape-memory alloy wire and a paraffin wax actuator to actuate movement of the at least one vent in response to a change in temperature within the first fluid region.

13. The fan system of claim 7, wherein the first fluid region is an environment located around the vehicle and the second fluid region is a passenger compartment for the vehicle.

14. The fan system of claim 7, wherein the first fluid region is an environment located around the vehicle and the second fluid region is an engine compartment for the vehicle.

15. The fan system of claim 7, wherein the first fluid region is an engine compartment for the vehicle and the second fluid region is a passenger compartment for the vehicle.

16. The fan system of claim 7, further including a battery to store energy from the energy harvesting system and to provide energy to the fan for driving the fan such that operation of the energy harvesting system and the fan may be independent from one another.

17. The fan system of claim 7, further including a flywheel to store energy from the energy harvesting system and to provide energy to the fan for driving the fan such that operation of the energy harvesting system and the fan may be independent from one another.

18. A method for changing a fluid temperature for a vehicle comprising:
driving a heat engine by converting thermal energy to mechanical energy with a shape-memory alloy disposed in contact with a first fluid region located within a vehicle and the second fluid region located outside a vehicle; and
driving a fan supported by the vehicle with the heat engine in response to a temperature difference between the first fluid region and the second fluid region.

19. The method of claim 17, further comprising actuating at least one vent located between the first fluid region and the second fluid region between an open position and a closed position is response to the temperature difference between the first fluid region and the second fluid region.

20. The method of claim 18, wherein actuating the at least one vent includes actuating a shape-memory alloy wire to actuate movement of the at least one vent in response to a change in temperature within the first fluid region.
